(19) United States
(12) Patent Application Publication
(10) Pub. No.: US 2006/0066791 A1
(43) Pub. Date: Mar. 30, 2006

(54) Vertical alignment active matrix liquid crystal display device

(75) Inventors: Ryota Mizusako, Sagamihara-shi (JP); Minoru Yamaguchi, Tokyo (JP); Yasushi Nakajima, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Casio Computer Co., Ltd., Tokyo (JP)

(21) Appl. No.: 11/238,027

(22) Filed: Sep. 28, 2005

(30) Foreign Application Priority Data
Sep. 30, 2004 (JP) 2004-289086

(51) Int. Cl. G02F 1/1337

(52) U.S. Cl. 349/123

(57) ABSTRACT

A liquid crystal display device comprises a TFT substrate where TFTs are formed, an opposing substrate (CF substrate), a liquid crystal with a negative dielectric anisotropy filled between both substrates, a pixel electrode, and an auxiliary electrode formed around the pixel electrode. The pixel electrode has a recess portion formed by etching a gate insulation film. The liquid crystal molecules are aligned tilted toward the center of a pixel according to the shape of the recess portion.

### BACKGROUND OF THE INVENTION

1. Field of the Invention

The present invention relates to a vertical alignment active matrix liquid crystal display device whose liquid crystal molecules are aligned vertical to the surface of a substrate.

2. Description of the Related Art

A conventional TFT liquid crystal panel comprises a TFT (Thin Film Transistor) substrate on which TFTs and pixel electrodes and the like are formed, a CF (Color Filter) substrate on which color filters and an opposing electrode are formed, and a liquid crystal layer which is sandwiched between those substrates. A TFT liquid crystal display panel which has liquid crystal molecules homogeneously aligned, such as a TN (Twisted Nematic) liquid crystal display device, uses a material with a positive dielectric anisotropy. A TFT liquid crystal display panel which has liquid crystal molecules homeotropically aligned uses a material with a negative dielectric anisotropy, and aligns the director (molecular long axis direction) perpendicular to the substrate with no electric field formed (initial aligned state).

In the vertical alignment TFT liquid crystal display device whose liquid crystal molecules are homeotropically aligned in the initial aligned state, a vertical alignment film is formed on the opposing inner surfaces of a pair of substrates arranged opposite to each other, and a liquid crystal with the negative dielectric anisotropy is filled between the substrates, thereby constituting a liquid crystal cell.

In the liquid crystal cell, a plurality of pixel electrodes are formed on one of the pair of substrates, and an opposing electrode which faces the picture electrodes is formed on the other substrate, with one pixel being formed by each pixel electrode, the opposing portion of the common electrode, and the liquid crystal therebetween. A vertical alignment film, which is rubbed to define a direction in which the liquid crystal molecules tilt when a voltage is applied between the pixel electrode and the opposing electrode, is so formed on each substrate as to cover the pixel electrode and the opposing electrode.

When no voltage is applied between the pixel electrode and the opposing electrode, because the opposing electrode and the pixel electrode have the same electric potential, no electric field is generated between those electrodes, and the action of the vertical alignment film causes the liquid crystal molecules to be aligned vertical to the substrate.

When a voltage is applied between the pixel electrode and the opposing electrode, the liquid crystal molecules behave to tilt because of the electric field formed between those electrodes. When a sufficiently high voltage is applied between the pixel electrode and the opposing electrode, the liquid crystal molecules are aligned substantially horizontal to the substrate.

In this case, when a voltage is applied between the pixel electrode and the opposing electrode, the liquid crystal molecules are aligned along one direction due to the electric field formed between those electrodes, and alignment restricting force originating from rubbing of the vertical alignment film. This results in a large view angle dependency of the contrast and a poor view angle characteristic.

To obtain a wide view angle characteristic in the vertical alignment liquid crystal display apparatus, a liquid crystal display device whose vertical alignment film does not undergo a rubbing process is proposed. In the liquid crystal display device, when a voltage is applied between the opposing electrodes, the liquid crystal molecules aligned in such a way as to be spiral for each pixel, but the center position of the spiral fluctuates due to a change in the gap between the electrodes in each pixel, the fluctuation of the electric field intensity, and so forth. This causes display unevenness or irregularity.

There also is a proposal to form a plurality of domains where the liquid crystal molecules are aligned along plural directions pixel by pixel. For instance, as described in the specification of Japanese Patent Publication No. 2565639, a liquid crystal display apparatus proposed has the opposing electrode formed with an aperture with the shape of a letter X, so that the liquid crystal molecules in each pixel are so aligned as to tilt toward the center of the X-shaped aperture along the four directions when a voltage is applied between the two electrodes facing each other.

In this liquid crystal display apparatus, the opposing electrode is formed larger than the pixel electrode, and when a voltage is applied between the pixel electrode and the opposing electrode, a vertical electric field (an electric field vertical to the substrate) is generated at that portion of the pixel region where the pixel electrode faces the opposing electrode, and an oblique electric field is generated at the peripheral portion of the pixel electrode, thereby forming a discontinuous electric field portion at that portion of the opposing electrode where the slit is formed. The liquid crystal molecules are aligned to tilt toward the center of the X-shaped aperture due to the discontinuous electric field portion. That is, in this liquid crystal display apparatus, the liquid crystal molecules are so aligned as to tilt along the four directions for each pixel and for each region defined by the X-shaped aperture.

According to the above-described liquid crystal display apparatus, however, because the X-shaped aperture formed in each pixel forms regions with different alignment directions, the X-shaped aperture should be formed wide enough to prohibit the interaction between the regions. Accordingly, in each pixel, the area of the aperture (slit) which is not controllable by the electric field becomes large, and the area of the opposing electrode becomes small, resulting in a low aperture ratio.

### SUMMARY OF THE INVENTION

It is an object of the present invention is to provide a liquid crystal display device which has bright display and a wide view angle without display unevenness.

To achieve the object, a liquid crystal display device according to the first aspect of the present invention comprises:

a first substrate provided with a first electrode;

a second substrate which is provided with at least one second electrode arranged opposite to the first electrode with a predetermined gap therebetween, and forming individual pixel regions with that region which faces the first electrode;

an auxiliary electrode formed on that surface of the second substrate on which the second electrode is provided, along at least a periphery of the pixel region;

a vertical alignment film formed on each of opposing inner surfaces of the first electrode and the second electrode;

a liquid crystal layer with a negative dielectric anisotropy filled between the first and second substrates;

at least one of a recess portion and a projecting portion, which is formed on at least one of the first and second electrodes, at a position corresponding to substantially a center of the pixel region, for aligning liquid crystal molecules of the liquid crystal layer according to a shape of the at least one of the recess portion and the projecting portion.

In the liquid crystal display device according to the first aspect, the recess portion or the projecting portion, which is formed on at least one of the first and second electrodes, tilts the liquid crystal molecules in the vicinity of the recess portion or the projecting portion so as to face the center of the pixel, so that the liquid crystal molecules at the peripheral portion of the pixel region is tilted toward the center of the pixel by the horizontal electric field that is generated between the second electrode and the auxiliary electrode. Therefore, a monodomain where the liquid crystal molecules are aligned spirally toward the center of the pixel region from the peripheral portion of the pixel is formed for each pixel region, and the spiral center of the alignment of the liquid crystal molecules becomes steady over the entire pixel regions. This provides a stable and uniform aligned state, thus suppressing the occurrence of display unevenness.

In the liquid crystal display device of the invention, the recess portion may be formed at substantially a center of the second electrode, or the projecting portion may be formed at a position corresponding to the center of the pixel region of the first electrode. When the projecting portion is formed at the first electrode, the projecting portion may be a projection made of an insulating material formed on the first electrode, or a projection comprising a light shielding film may be formed at that portion of the first substrate which corresponds to the center of the pixel region of the first electrode. When a color filter corresponding to each pixel region, and a black mask of a light-shielding resin are formed on the first substrate for each pixel region, the black mask being located at a position where the black mask covers around each pixel region, it is desirable that the projecting portion formed at the position corresponding to the center of the pixel region of the first electrode should be formed by a projection of a resin for forming the black mask formed between the first substrate and the color filter.

It is desirable that in the liquid crystal display device of the invention, a peripheral projecting portion extending along a peripheral portion of the pixel region should be further formed on the second substrate. It is preferable that the peripheral projecting portion should be formed by an insulation film formed in such a way that an edge of the insulation film overlies a part of the auxiliary electrode.

A liquid crystal display device according to the second aspect of the invention comprises a first substrate provided with a first electrode;

a second substrate which is provided with at least one second electrode arranged opposite to the first electrode with a predetermined gap therebetween, and forming individual pixel regions with that region which faces the first electrode;

an auxiliary electrode formed on that surface of the second substrate on which the second electrode is provided, along at least a periphery of the pixel region;

a vertical alignment film formed on each of opposing inner surfaces of the first electrode and the second electrode;

a liquid crystal layer with a negative dielectric anisotropy filled between the first and second substrates;

at least one of a recess portion and a projecting portion, which is formed on at least one of the first and second electrodes, at a position corresponding to substantially a center of the pixel region, for defining a center position of alignment of liquid crystal molecules to be aligned spirally toward a center from a peripheral portion by an electric field to be applied between the second electrode and the auxiliary electrode.

In the liquid crystal display device according to the second aspect, as the center position of the liquid crystal molecules in the spiral alignment in each pixel region is defined by at least one of the recess portion and the projecting portion, which is formed on at least one of the first and second electrodes at the position corresponding to substantially the center of the pixel region, the spiral alignment of the liquid crystal molecules is acquired stably, and the occurrence of display unevenness is suppressed.

It is desirable that in the liquid crystal display device of the invention, the recess portion should be formed at a center of the second electrode of the second substrate, in which case it is preferable that a peripheral projecting portion extending formed along a peripheral portion of the pixel region should be further provided on the second substrate.

In the liquid crystal display device of the invention, the projecting portion may be formed at a position corresponding to the center of the pixel region of the first electrode. In this case, a peripheral projecting portion extending along a peripheral portion of the pixel region should further be formed on the second substrate.

When a color filter corresponding to the pixel region is formed on that surface of the first substrate which faces the second substrate, the projecting portion formed on the first electrode may be formed by a projection provided at the color filter.

It is desirable that in the liquid crystal display device of the invention, the auxiliary electrode should be set to a potential lower than that of the second electrode. It is preferable that the auxiliary electrode should comprise a compensating-capacitor electrode which overlies a peripheral portion of the second electrode and form a compensating capacitor between the compensating-capacitor electrode and the second electrode. When a projecting portion comprising an insulation film is formed on an inner surface of the first substrate at a position corresponding to the center of the pixel region, it is desirable that a metal film for shielding light transmitting a center of the projecting portion should be formed on the first substrate. Further, the projecting portion may comprise a spacer for adjusting a gap between the first electrode and the second electrode.

A liquid crystal display device according to the third aspect of the invention comprises:

a first substrate provided with a first electrode;

a second substrate which is provided with at least one second electrode arranged opposite to the first electrode with a predetermined gap therebetween, and forming individual pixel regions with that region which faces the first electrode;

an auxiliary electrode formed on that surface of the second substrate on which the second electrode is provided, along at least a periphery of the pixel region;

a vertical alignment film formed on each of opposing inner surfaces of the first electrode and the second electrode; and

a liquid crystal layer with a negative dielectric anisotropy filled between the first and second substrates,

wherein at least one of the first and second electrodes is formed inclined toward a peripheral portion of the pixel region from a center thereof in such a way that molecular long axes of liquid crystal molecules of the liquid crystal layer are aligned tilted toward the center of the pixel region.

According to the liquid crystal display device of the third aspect, as at least one of the first and second electrodes is formed tilted toward the peripheral portion from the center of each pixel region, the liquid crystal molecules are aligned spirally toward the center of each pixel region from the peripheral portion thereof, thus making the aligned state of the liquid crystal molecules in each pixel region stable.

It is preferable that in the liquid crystal display device according to the invention, a color filter having a cross section formed in such a way that a center portion is thicker than a peripheral portion should be provided on that surface of the second substrate which faces the first substrate.

### BRIEF DESCRIPTION OF THE DRAWINGS

These objects and other objects and advantages of the present invention will become more apparent upon reading of the following detailed description and the accompanying drawings in which:

FIG. 1 is a plan view schematically illustrating the structure of one pixel of a vertical alignment liquid crystal display device according to a first embodiment of the invention;

FIG. 2 is a cross-sectional view of one pixel illustrated in FIG. 1 cut along the line II-II;

FIG. 3 is a cross-sectional view showing the pixel structure of a liquid crystal display device according to a second embodiment of the invention;

FIG. 4 is a cross-sectional view showing the pixel structure of a modification of the second embodiment of the invention;

FIG. 5 is a cross-sectional view showing the pixel structure of another modification of the second embodiment of the invention;

FIG. 6 is a cross-sectional view illustrating the pixel structure of a liquid crystal display device according to a third embodiment of the invention;

FIG. 7 is a cross-sectional view exemplarily illustrating the aligned state of liquid crystal molecules in the liquid crystal display device according to the third embodiment of the invention without any electric field;

FIG. 8 is a cross-sectional view exemplarily illustrating the aligned state of liquid crystal molecules in the liquid crystal display device according to the third embodiment of the invention with an electric field applied;

FIG. 9 is a cross-sectional view exemplarily illustrating the aligned state of liquid crystal molecules in the liquid crystal display device according to a fourth embodiment of the invention without any electric field; and

FIG. 10 is a cross-sectional view exemplarily illustrating the aligned state of liquid crystal molecules in the liquid crystal display device according to the fourth embodiment of the invention with an electric field applied.

### DETAILED DESCRIPTION OF THE PREFERRED EMBODIMENTS

Liquid crystal display devices according to embodiments of the present invention will be described below with reference to the accompanying drawings.

### First Embodiment

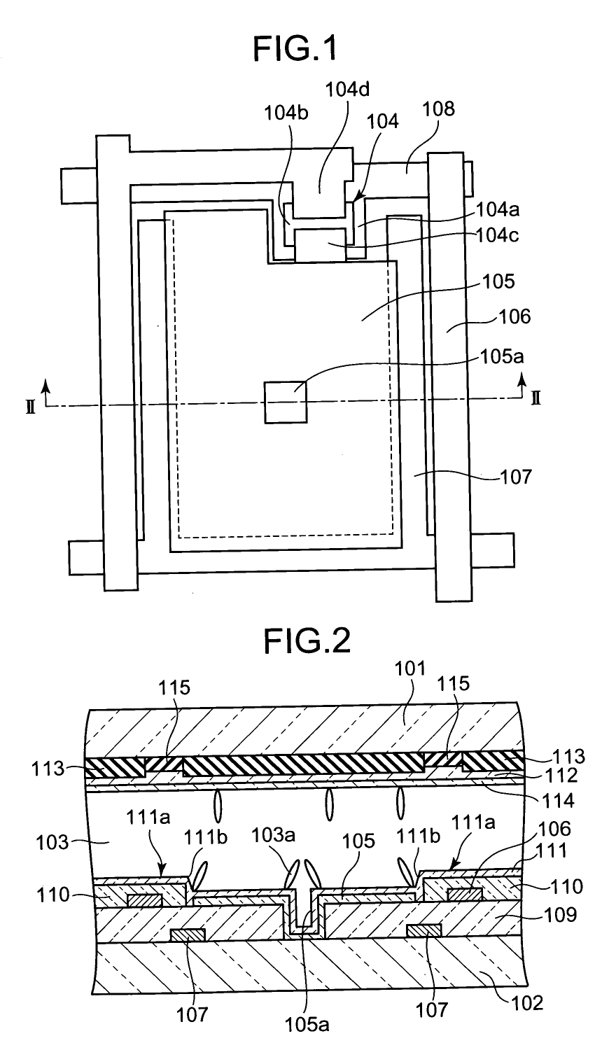

FIG. 1 is a top plan view schematically illustrating one pixel structure of a vertical alignment liquid crystal display device according to the first embodiment of the invention. FIG. 2 is a cross-sectional view of one pixel illustrated in FIG. 1 cut along the line II-II. In FIG. 2, liquid crystal molecules are represented by long ellipses as a model.

The liquid crystal display device comprises a pair of glass substrates 101 and 102, arranged opposite to each other, and a liquid crystal 103 with the negative dielectric anisotropy, filled between one glass substrate 102 (hereinafter called TFT substrate 102) and the other glass substrate 101 (hereinafter called opposing substrate 101).

Formed on the surface of the TFT substrate 102 opposing the opposing substrate 101 are TFT devices 104, pixel electrodes 105, drain lines 106, auxiliary electrodes 107, gate lines 108, a gate insulation film 109, an insulation film 110, and an alignment film 111. Formed on the inner surface of the opposing substrate 101 are an opposing electrode 112, a color filter 113, an alignment film 114, and a black mask 115.

The TFT device 104 is an inversely staggered thin film transistor which is formed on the glass substrate 102. The TFT device 104 has a gate electrode 104a, a semiconductor layer 104b, a source electrode 104c, and a drain electrode 104d.

The pixel electrode 105 is formed by an approximately quadrangle transparent electrode which comprises, for example, an ITO film essentially consisting of an indium oxide. The center or the base point of alignment of the liquid crystal molecules are formed at substantially the center in a single pixel electrode 105, and a recess portion 105a with a circular or polygonal (e.g., quadrangle) planar shape for providing a step is formed at that center. The recess portion 105a is formed by forming a hole in the gate insulation film 109, and depositing the pixel electrodes 105 and the alignment film 111 on the hole. Each of the pixel electrodes 105 defines a single pixel region or the smallest unit for forming an image with that region which faces the opposing electrode 112. Laying out a plurality of pixel regions forms the display region of the liquid crystal display device.

The drain line 106 of the liquid crystal display panel of the embodiment comprises an aluminum line or the like which is so formed as to run along the column direction for each column of pixels. The drain line 106 is connected to the drain electrodes 104d of the TFT devices 104 in the same pixel column, and supplies the image signal from a column driver to the pixel electrode 105, via the enabled TFT devices 104.

The auxiliary electrode 107, which is formed of aluminum or the like, comprises a portion, which is so formed as to partly overlie the peripheral portion of the pixel electrode 105 via the gate insulation film 109. The auxiliary electrode 107 is set at a predetermined electric potential lower than that of the pixel electrode 105, and, more preferably, at the same electric potential as that of the opposing electrode 112. The auxiliary electrodes 107, together with the pixel electrode 105, forms the compensating capacity which is connected in parallel to a pixel capacitor, formed by each pixel electrode 105, the opposing electrode 112 and the liquid crystal 103.

The gate line 108 comprises an aluminum line or the like which is so formed as to run along the row direction for each pixel row, and electrically insulated from the other electrodes by the gate insulation film 109. The gate line 108 is connected to the gate electrodes 104a of the TFT devices 104 in the corresponding pixel row, supplies a scan signal to the TFT devices 104, and controls the ON/OFF actions of the TFT devices 104.

The gate insulation film 109 is formed on the substrate 102 on which the gate electrodes 104a of the TFT devices 104, the gate line 108, and the auxiliary electrode 107 are formed, and comprises, for example, a silicon nitride film. The gate insulation film 109 electrically insulates the gate electrode 104a of the TFT device 104 from the semiconductor layer 104b and the source/drain electrodes 104c, and 104d which are opposite to that gate electrode. The source electrode 104c of the TFT device 104 is connected to the corresponding pixel electrode 105, and the drain electrode 104d of the TFT device 104 is connected to the corresponding drain line 106.

The insulation film 110, which covers the drain line 106, is formed between the pixel electrode 105 and that of the neighboring pixel, and comprises, for example, a silicon nitride film. The insulation film 110 provides a whose peripheral portion is thicker than the pixel region, and which forms an inclined portion 111b on the surface of the alignment film 111.

Each of the alignment films 111 and 114 comprises hexamethyldisiloxane-polymerization film or the like which is formed by coating and baking of an organic vertical alignment material, or CVD (Chemical Vapor Deposition). The alignment films 111 and 114 are so formed as to respectively cover the pixel electrode 105 and the opposing electrode 112. The liquid crystal 103 is filled between those alignment films 111 and 114. The alignment films 111 and 114 are not rubbed, and the liquid crystal molecules near their surfaces are vertically aligned to the alignment film surface when no electric field is generated.

Next, the method of manufacturing the liquid crystal display device with the above-described structure will be explained.

An aluminum metal film is formed on the one glass substrate 102, and patterned to form the gate electrodes 104a of the TFT devices 104, the gate lines 108, and the auxiliary electrodes 107 (including the lines which mutually connect the auxiliary electrodes 107). Next, the gate insulation film 109 is formed by CVD. Subsequently, channel layers (semiconductor layers 104b), the source regions, the drain regions, etc. of the TFT devices 104 are formed on the gate insulation film 109. Subsequently, a recess portion having a quadrangle cross section is formed on the gate insulation film 109 at a position corresponding to substantially the center in a single pixel region.

Then, an ITO film is formed on the gate insulation film 109 formed with the recess portion by sputtering. The ITO film is etched and patterned, excluding that portion of the ITO film which constitutes the pixel region, yielding the pixel electrodes 105 each formed with the recess portion 105a formed at the center of each pixel region.

The drain lines 106 are formed on the gate insulation film 109, apart from the peripheries of the pixel electrodes 105, and are connected to the drain electrodes 104d of the TFT devices 104. The insulation film 110 is formed on the gate insulation film 109 in such a manner as to cover the drain lines 106 formed on non-pixel regions around the pixel electrodes 105.

Subsequently, the alignment film 111 is formed on the entire surface of the substrate by CVD, spin coating, or the like.

The TFT substrate 102 thus formed and the opposing substrate 101 on which the opposing electrode 112, the color filter 113, etc. are formed, are arranged opposite to each other with a non-illustrated spacer sandwiched therebetween, and their peripheries are sealed by a seal material, thereby forming each liquid crystal cell. Next, the liquid crystal with the negative dielectric anisotropy is filled in the liquid crystal cell, and a liquid-crystal inlet is sealed. Non-illustrated polarizing plates are placed on the outer surfaces of the TFT substrate 102 and the opposing substrate 101, thereby fabricating the liquid crystal display device.

Next, the behavior of the liquid crystal molecules in the pixel with the above-described structure will be explained.

In a no electric field state where no voltage is applied between the opposing pixel electrodes 105 and opposing electrode 112, the liquid crystal molecules 103a of the liquid crystal 103 having the negative dielectric anisotropy are aligned vertical to the top surface of the TFT substrate 102 and the opposing substrate (CF substrate) 101. That is, the liquid crystal molecules 103a positioned inside each pixel electrode are aligned vertical to the top surfaces of the TFT substrate 102 and the opposing substrate 101. As the inclined surface 111b are formed on the surface of the alignment film by the peripheral projecting portion 111a formed at the peripheral portion, the liquid crystal molecules 103a positioned at the peripheral portion of each pixel region are aligned vertical to the inclined surface 111b, i.e., aligned tilted toward inside the pixel region. As the force that makes the liquid crystal molecules 103a aligned vertical to the alignment film 111 formed on the surface of the recess portion 105a at the center of the pixel region along the corners of the recess portion 105a acts on the liquid crystal molecules 103a near the recess portion 105a, the liquid crystal molecules 103a are tilted so as to be directed toward the center of the pixel region and are thus aligned inclined toward the center of the pixel region.

When a voltage is applied between the opposing pixel electrodes 105 and opposing electrode 112 and a voltage with a predetermined potential lower than the potential of the pixel electrodes 105, e.g., a potential equal to the potential of the opposing electrode 112, is applied to the auxiliary electrodes 107 formed around the pixel region, a horizontal electric field (an electric field substantially parallel to the substrate surface) is generated between the pixel electrodes 105 and the auxiliary electrodes 107. Accordingly, the directors (molecular long axes) of the individual liquid crystal molecules are tilted toward the center of the pixel for the peripheral portion of the pixel region by the horizontal electric field.

Further, the liquid crystal molecules 103a near the recess portion 105a of the pixel electrodes 105 are so aligned as to lean toward the center of the recess portion 105a, defining the center of alignment. Accordingly, the liquid crystal molecules at the peripheral portion of the pixel region are aligned substantially horizontal to the substrate surface toward the center of the pixel electrode into a continuous spiral alignment state around the recess portion 105a by the mutual electric field between the pixel electrodes 105 and the opposing electrode 112 and the auxiliary electrodes 107, and the alignment restricting force according to the shape of the surface of the alignment film at the peripheral portion of the pixel (shape of the inclined surface 111b made by the peripheral projecting portion 111a), yielding a substantially monodomain where the alignment of the liquid crystal molecules 103a changes pixel by pixel. Therefore, the alignment of the liquid crystal molecules in each pixel region becomes stabilized and uniform.

According to the invention, as described above, the liquid crystal molecules 103a at the center portion of the pixel region are tilted to face the center of the pixel, so that the liquid crystal molecules 103a at the peripheral portion of the pixel region are tilted toward the center of the pixel by the horizontal electric field generated between the pixel electrodes 105 and the auxiliary electrodes 107, and further by the alignment restricting force according to the shape of the surface of the alignment film at the peripheral portion of the pixel. Therefore, for each pixel region, a monodomain is formed where the liquid crystal molecules 103a are aligned spirally toward the center of the pixel region from the peripheral portion of the pixel, the spiral center of the alignment of the liquid crystal molecules becomes steady, providing a stable and uniform aligned state. This suppresses the occurrence of display unevenness.

### Second Embodiment

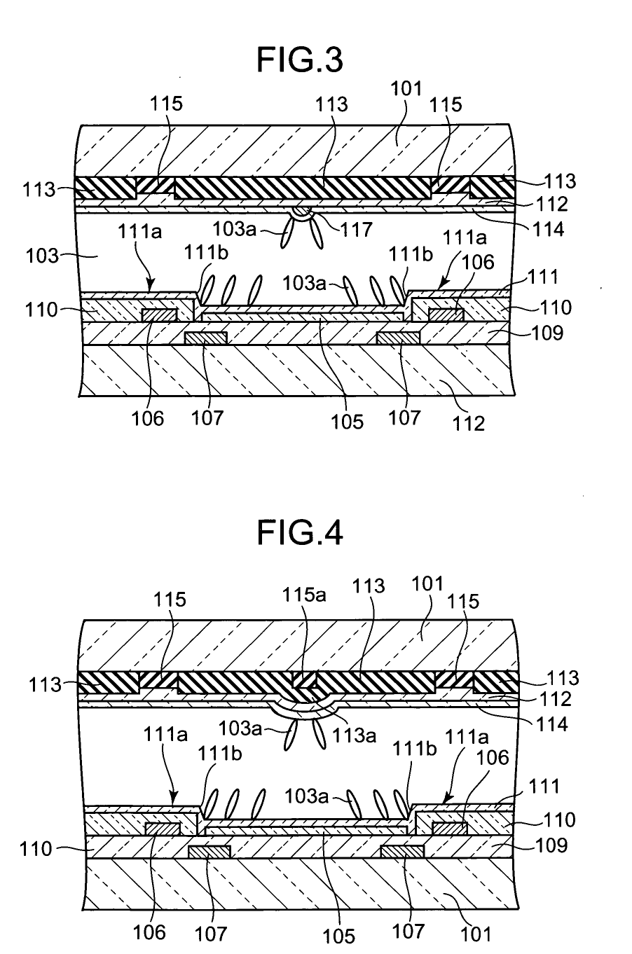

The second embodiment of the invention will be explained referring to FIG. 3.

FIG. 3 illustrates the pixel structure of a liquid crystal display device according to the second embodiment.

In FIG. 3, formed on the inner surface of the TFT substrate 102 are the TFT devices 104, the pixel electrodes 105, the drain lines 106, the auxiliary electrodes 107, the gate lines 108, the gate insulation film 109, the insulation film 110, and the alignment film 111. The opposing electrode 112, the color filter 113, the alignment film 114, and the black mask 115 are formed on the inner surface of the opposing substrate 101. In the embodiment, the same constituting elements as those of the first embodiment will be denoted by the same reference numbers to avoid repeating their otherwise redundant descriptions.

In the embodiment, the color filter 113 is formed by coating a color resist solution of acrylic resin and exposing the resultant resist film in a pattern, and developing the exposed film, and has any of red (R), green (G) and blue (B) corresponding to the three primary colors. The color filter 113 is so formed as to face the pixel electrode 105.

The opposing electrode 112 of the opposing substrate 101 is so formed as to commonly face a plurality of pixel electrodes 105. The opposing electrode 112 is formed of a transparent conductive material, such as ITO.

A projecting portion 117 is formed on the opposing electrode 112 at that portion which corresponds to the center of the pixel electrodes 105. The projecting portion 117 is obtained by forming a photosensitive layer on the opposing electrode 112, then forming the layer into a hemispherical shape by photolithography.

Formed on the opposing electrode 112 where the projecting portion 117 is formed is the alignment film 111 which covers the opposing electrode 112 and the projecting portion 117.

With no voltage applied between the opposing electrode 112 and the pixel electrodes 105, the force that aligns the liquid crystal molecules at the center portion of each pixel region vertical to the alignment film 114 covering the surface of the projecting portion 117 along the surface shape of the projecting portion 117, so that tilting in the direction toward the center of the pixel as seen from the pixel electrodes 105 is given. As the inclined surface 111b is formed on the surface of the alignment film by the peripheral projecting portion 111a formed at the peripheral portion, the liquid crystal molecules 103a positioned at the peripheral portion of each pixel region are aligned vertical to the inclined surface 111b, i.e., inclined toward inside the pixel region.

When a voltage is applied, the center portions of the pixel region becomes the center of the spiral, and the liquid crystal molecules 103a at the peripheral portion of the pixel region are tilted toward the center of the pixel by the horizontal electric field formed between the pixel electrodes 105 and the auxiliary electrode 107, and further by the alignment restricting force according to the shape of the inclined surface 111b generated by the peripheral projecting portion 111 a at the peripheral portion of the pixel. Therefore, the liquid crystal molecules 03a are aligned with the projecting portion 117 as the spiral center, thereby stabilizing the aligned state of the liquid crystal molecules in the pixel region.

In this case, because the liquid crystal molecules 103a at the center portion of each pixel region uniformly receives the intermolecular force from the liquid crystal molecules 103a at the peripheral portion which lean toward the center, the liquid crystal molecules 103a are aligned vertical to the substrate surface.

In the embodiment, a photosensitive material is used for the projecting portion 117. A known photosensitive resin or the like is adopted as the photosensitive material, and a material which becomes transparent or shields light after exposure may be used as well.

In the embodiment, the photosensitive material layer is formed on the opposing electrode 112, and then so shaped as to be the projecting portion 117 by photolithography. However, the projecting portion 117 is not limited to the photosensitive material, but may be a color filter. Alternatively, as shown in FIG. 4, a projecting portion 115a may be formed on the opposing substrate 101 corresponding to the center of the pixel electrode 105 by the resin black mask 115 beforehand, then the color filter 113 may be deposited and patterned on the projecting portion 115a, thereby forming a part of the color filter 113 as a projection 113a.

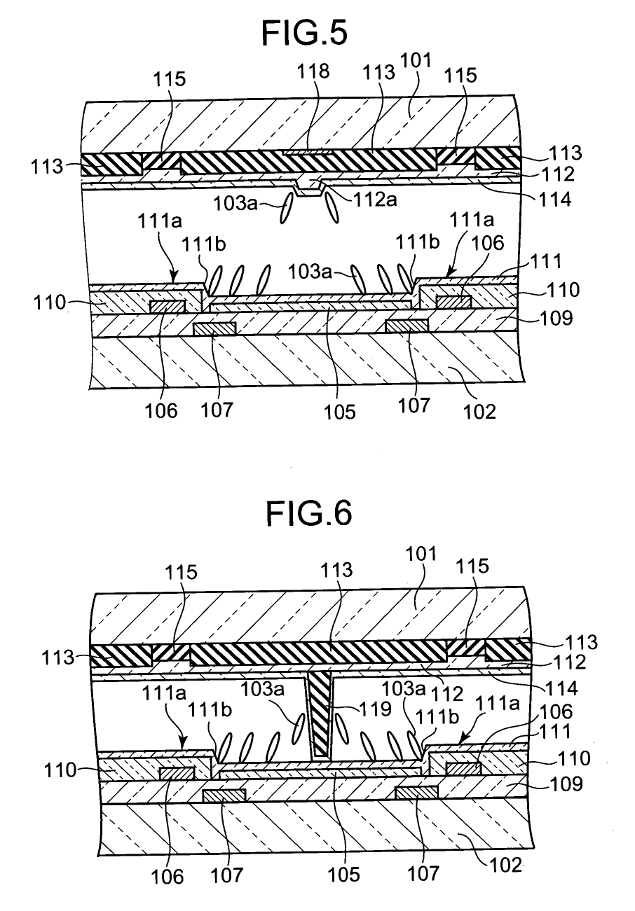

As shown in FIG. 5, a projection 112a provided on the opposing substrate 101 at a position corresponding to the center of the pixel electrode 105 may be formed by making a part of the opposing electrode 112 thicker.

A light-shielding film 118 of metal may be formed at that portion of the opposing substrate 101 which corresponds to the projection 112a, particularly, at the center of the projection 112a. In this case, as the liquid crystal molecules at the center portion of the pixel region are aligned vertically, light leakage from the center portion of the can be prevented, thus improving the contrast.

### Third Embodiment

In the liquid crystal display device according to the invention, the above-described projecting portion in the second embodiment may be a spacer formed by patterning a transparent resin material on the opposing electrode.

In a liquid crystal display device according to the third embodiment of the invention, as shown in FIG. 6, a spacer 119 is formed like a cone with an inclined side, and the alignment film 114 is so formed as to cover the spacer 119. As the third embodiment is identical to the second embodiment in structure except for the spacer 119, the same constituting elements as those of the second embodiment will be denoted by the same reference numbers to avoid repeating otherwise redundant descriptions.

According to the third embodiment, when a voltage is applied between the opposing electrode 112 and the pixel electrodes 105, the liquid crystal molecules 103a are influenced by the inclined side of the spacer 119 and aligned radially around the spacer 119. Therefore, the aligned state of the liquid crystal molecules 103a becomes stable in each pixel region.

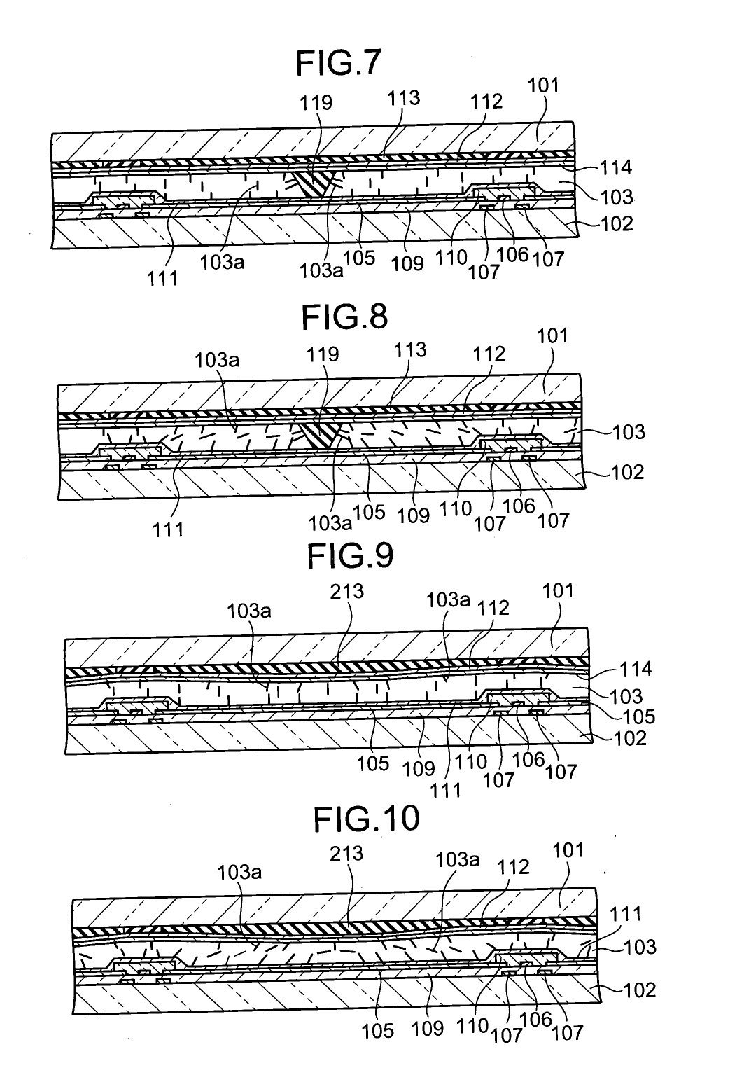

In the embodiment, the aligned state of the liquid crystal molecules with no electric field applied is exemplarily illustrated in FIG. 7, and the aligned state of the liquid crystal molecules with an electric field applied is exemplarily illustrated in FIG. 8. As shown in FIGS. 7 and 8, the liquid crystal molecules 103a near the spacer 119 are aligned approximately vertical to the inclined side of the spacer 119, so that with an electric field applied, the liquid crystal molecules 103a are aligned spirally with the liquid crystal molecules 103a near the spacer 119 as the center, ensuring the stable aligned state of the liquid crystal molecules 103a.

### Fourth Embodiment

Although the projecting portion 117 located at the center of the pixel region is formed hemispherical in the second embodiment, the shape of the projecting portion 117 is not limited to the hemispherical shape. Provided that tilting toward the center of the pixel is given, the projecting portion 117 may be shaped to be thicker at the center and thinner at the peripheral portion.

In the invention, a color filter 213 has an angular shape thicker at the center portion of each pixel region and thinner at the peripheral portion, as shown in FIGS. 9 and 10. As the fourth embodiment is identical to the second embodiment in structure except for the color filter, the same constituting elements as those of the second embodiment will be denoted by the same reference numbers to avoid repeating otherwise redundant descriptions.

In the fourth embodiment, the aligned state of the liquid crystal molecules with no electric field applied is exemplarily illustrated in FIG. 9, and the aligned state of the liquid crystal molecules with an electric field applied is exemplarily illustrated in FIG. 10. As shown in FIGS. 9 and 10, the liquid crystal molecules adjoining to the alignment film on the opposing substrate 101 are aligned approximately vertical to the curved surface of the color filter, so that the liquid crystal molecules are aligned tilted to the normal direction of the TFT substrate. That is, the liquid crystal molecules on the right of the pixel center are tilted leftward, and the liquid crystal molecules on the left of the pixel center are tilted rightward, as shown in FIG. 9. When a voltage is applied in this situation, as shown in FIG. 10, the liquid crystal molecules 103a are aligned spirally toward the center from the peripheral portion of each pixel region due to the influence of the liquid crystal molecules 103a adjoining to the opposing substrate 101. Therefore, the aligned state of the liquid crystal molecules 103a in each pixel region becomes stable.

The invention is not limited to the embodiments, but may be adapted and modified as needed.

The recess portion 105a is formed on the pixel electrodes 105 in the first embodiments, while the projecting portion 117 or the is formed on the opposing electrode 112 in the second embodiments. The recess portion 105a, and the projecting portion 117 or the like may be formed on either one of the pixel electrodes 105 and the opposing electrode 112.

Although the TFT device 104 has been mentioned to be an inversely staggered type (bottom gate type), the gate structure of the TFT device is not restrictive, and may be a top gate type.

Although the drain lines 106, the auxiliary electrodes 107, and the gate lines 108 are formed of aluminum or the like in the embodiments, the electrodes or the lines may be formed of another material, e.g., copper. Particularly, it is desirable that the auxiliary electrode 107 should be formed by a transparent conductive film. In this case, the transmittance of each pixel region is improved.

Although the gate insulation film 109 is illustrated as a silicon nitride film in the embodiments, the gate insulation film may be another insulation film like a silicon oxide film.

Various embodiments and changes may be made thereunto without departing from the broad spirit and scope of the invention. The above-described embodiments are intended to illustrate the present invention, not to limit the scope of the present invention. The scope of the present invention is shown by the attached claims rather than the embodiments. Various modifications made within the meaning of an equivalent of the claims of the invention and within the claims are to be regarded to be in the scope of the present invention.

This application is based on Japanese Patent Application No. 2004-289086 filed on Sep. 30, 2004 and including specification, claims, drawings and summary. The disclosure of the above Japanese Patent Application is incorporated herein by reference in its entirety.

What is claimed is:

1. A liquid crystal display device comprising:
a first substrate provided with a first electrode;
a second substrate which is provided with at least one second electrode arranged opposite to the first electrode with a predetermined gap therebetween, and forming individual pixel regions with that region which faces the first electrode;
an auxiliary electrode formed on that surface of the second substrate on which the second electrode is provided, along at least a periphery of the pixel region;
a vertical alignment film formed on each of opposing inner surfaces of the first electrode and the second electrode;
a liquid crystal layer with a negative dielectric anisotropy filled between the first and second substrates;
at least one of a recess portion and a projecting portion, which is formed on at least one of the first and second electrodes, at a position corresponding to substantially a center of the pixel region, for aligning liquid crystal molecules of the liquid crystal layer according to a shape of the at least one of the recess portion and the projecting portion.

2. The liquid crystal display device according to claim 1, wherein the recess portion is formed at substantially a center of the second electrode.

3. The liquid crystal display device according to claim 1, wherein the projecting portion is formed at a position corresponding to the center of the pixel region of the first electrode.

4. The liquid crystal display device according to claim 3, wherein the projecting portion formed at the position corresponding to the center of the pixel region of the first electrode is a projection made of an insulating material formed on the first electrode.

5. The liquid crystal display device according to claim 3, wherein a projection comprising a light shielding film is formed at that portion of the first substrate which corresponds to the projecting portion formed at the position corresponding to the center of the pixel region of the first electrode.

6. The liquid crystal display device according to claim 3, wherein a color filter corresponding to each pixel region, and a black mask of a light-shielding resin are formed on the first substrate for each pixel region, the black mask being located at a position where the black mask covers around each pixel region, and
the projecting portion formed at the position corresponding to the center of the pixel region of the first electrode is formed by a projection of a resin for forming the black mask formed between the first substrate and the color filter.

7. The liquid crystal display device according to claim 1, wherein a peripheral projecting portion extending along a peripheral portion of the pixel region is further formed on the second substrate.

8. The liquid crystal display device according to claim 7, wherein the peripheral projecting portion formed on the second substrate comprises an insulation film formed in such a way that an edge of the insulation film overlies a part of the auxiliary electrode.

9. A liquid crystal display device comprising:
a first substrate provided with a first electrode;
a second substrate which is provided with at least one second electrode arranged opposite to the first electrode with a predetermined gap therebetween, and forming individual pixel regions with that region which faces the first electrode;
an auxiliary electrode formed on that surface of the second substrate on which the second electrode is provided, along at least a periphery of the pixel region;
a vertical alignment film formed on each of opposing inner surfaces of the first electrode and the second electrode;
a liquid crystal layer with a negative dielectric anisotropy filled between the first and second substrates;
at least one of a recess portion and a projecting portion, which is formed on at least one of the first and second electrodes, at a position corresponding to substantially a center of the pixel region, for defining a center position of alignment of liquid crystal molecules to be aligned spirally toward a center from a peripheral portion by an electric field to be applied between the second electrode and the auxiliary electrode.

10. The liquid crystal display device according to claim 9, wherein the recess portion is formed on the second electrode of the second substrate.

11. The liquid crystal display device according to claim 9, wherein the recess portion is formed at a center of the second electrode of the second substrate, and a peripheral projecting portion extending formed along a peripheral portion of the pixel region is further provided on the second substrate.

12. The liquid crystal display device according to claim 9, wherein the projecting portion is formed at a position corresponding to the center of the pixel region of the first electrode.

13. The liquid crystal display device according to claim 9, wherein the projecting portion is provided on the first substrate at a position corresponding to the center of the pixel region, and
a peripheral projecting portion extending along a peripheral portion of the pixel region is further formed on the second substrate.

14. The liquid crystal display device according to claim 9, wherein a color filter corresponding to the pixel region is formed on that surface of the first substrate which faces the second substrate, and
the projecting portion formed on the first electrode comprises a projection provided at the color filter.

15. The liquid crystal display device according to claim 9, wherein the auxiliary electrode is set to a potential lower than that of the second electrode.

16. The liquid crystal display device according to claim 9, wherein the auxiliary electrode comprises a compensating-capacitor electrode which overlies a peripheral portion of the second electrode and forms a compensating capacitor between the compensating-capacitor electrode and the second electrode.

17. The liquid crystal display device according to claim 9, wherein a projecting portion comprising an insulation film and a metal film for shielding light transmitting a center of the projecting portion are formed on an inner surface of the first substrate at a position corresponding to the center of the pixel region.

18. The liquid crystal display device according to claim 9, wherein the projecting portion comprises a spacer for adjusting a gap between the first electrode and the second electrode.

19. A liquid crystal display device comprising:
a first substrate provided with a first electrode;
a second substrate which is provided with at least one second electrode arranged opposite to the first electrode with a predetermined gap therebetween, and forming individual pixel regions with that region which faces the first electrode;
an auxiliary electrode formed on that surface of the second substrate on which the second electrode is provided, along at least a periphery of the pixel region;
a vertical alignment film formed on each of opposing inner surfaces of the first electrode and the second electrode; and
a liquid crystal layer with a negative dielectric anisotropy filled between the first and second substrates,
wherein at least one of the first and second electrodes is formed inclined toward a peripheral portion of the pixel region from a center thereof in such a way that molecular long axes of liquid crystal molecules of the liquid crystal layer are aligned tilted toward the center of the pixel region.

20. The liquid crystal display device according to claim 19, wherein a color filter having a cross section formed in such a way that a center portion is thicker than a peripheral portion is provided on that surface of the second substrate which faces the first substrate.
